(19) United States
(12) Patent Application Publication
(10) Pub. No.: US 2009/0320885 A1
(43) Pub. Date: Dec. 31, 2009

(54) SUBSTRATE TREATMENT APPARATUS

(76) Inventors: Kazuki INOUE, Kyoto (JP); Yasuhiko OHASHI, Kyoto (JP); Jun SAWASHIMA, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/407,049

(22) Filed: Mar. 19, 2009

(30) Foreign Application Priority Data
Jun. 27, 2008 (JP) 2008-168414

(51) Int. Cl. B08B 13/00

(52) U.S. Cl. 134/104.2

(57) ABSTRACT

A substrate treatment apparatus includes: a substrate holding unit horizontally holding a substrate; a substrate rotating unit rotating the substrate held by the substrate holding unit around a vertical axis of rotation; a treatment solution supply unit for supplying a treatment solution to the substrate rotated by the substrate rotating unit; an exhaust tub having an exhaust port and storing the substrate holding unit therein; a plurality of guards stored in the exhaust tub and vertically movable independently of one another; an exhaust passage forming unit forming a capture port opposed to the peripheral edge portion of the substrate held by the substrate holding unit for capturing the treatment solution splashing from the substrate while forming an exhaust passage reaching the exhaust port from the capture port by vertically moving the guards; and an exhaust pipe connected to the exhaust port for exhausting the atmosphere in the exhaust tub through the exhaust port.

### BACKGROUND OF THE INVENTION

1. Field of the Invention

The present invention relates to a substrate treatment apparatus for treating a substrate such as a semiconductor wafer, substrates for liquid crystal display devices, glass substrates for plasma display devices, substrates for an FED (Field Emission Display), substrates for optical disks, substrates for magnetic disks, substrates for magnetooptical disks or substrates for photomasks, for example.

2. Description of Related Art

In the process of manufacturing semiconductor devices or liquid crystal displays, a single substrate treatment apparatus treating substrates such as semiconductor wafers or glass substrates for liquid crystal display panels one by one may be employed in order to treat the substrates with treatment solutions. Substrate treatment apparatuses of this type include an apparatus recovering treatment solutions employed for treating substrates and recycling the recovered treatment solutions to subsequent treatments, in order to reduce consumption of the treatment solutions.

For example, U.S. Patent Application Publication No. 2008/078428 discloses a substrate treatment apparatus capable of individually recovering a plurality of types of treatment solutions. This substrate treatment apparatus includes a spin chuck which rotates a substrate while holding the substrate generally horizontally and a treatment cup storing this spin chuck. The treatment cup includes three structural members (first to third structural members) vertically movable independently of one another.

The first structural member integrally includes a bottom portion annular in plan view surrounding the periphery of the spin chuck and a first guide portion uprighted from this bottom portion. The first guide portion extends obliquely upward toward a central side (a direction approaching the axis of rotation of the substrate). In the bottom portion, a waste liquid groove for discharging treatment solutions employed for treating the substrate is formed inside the first guide portion, while an inner recovery groove and an outer recovery groove in the form of coaxial double rings for recovering the treatment solutions employed for treating the substrate are formed outside the first guide portion to surround the waste liquid groove. A waste liquid pipe for guiding the treatment solutions to waste liquid treating equipment is connected to the waste liquid groove, while recovery pipes for guiding the treatment solutions to recovery treating equipment are connected to the recovery grooves.

The second structural member integrally includes a second guide portion positioned outside the first guide portion and a cylindrical treatment solution separation wall coupled to the second guide portion and positioned outside the second guide portion. The second guide portion has a cylindrical lower end portion positioned on the inner recovery groove and an upper end portion extending obliquely upward from the upper end of the lower end portion toward the central side (the direction approaching the axis of rotation of the substrate). The second guide portion is provided to vertically overlap with the first guide portion of the first structural member, and formed to approach the first guide portion while keeping an extremely small clearance when the first structural member and the second structural member most approach each other. The treatment solution separation wall is in the form of a cylinder coupled to the outer peripheral edge portion of the upper end portion. The treatment solution separation wall is positioned on the outer recovery groove, and stored in the outer recovery groove to approach the outer recovery groove while keeping clearances between the same and the inner wall and the bottom portion of the outer recovery groove as well as the inner wall of the outer structural member when the first structural member and the second structural member most approach each other.

The third structural member includes a third guide portion positioned outside the second guide portion. The third guide portion has a lower end portion positioned on the outer recovery groove and an upper end portion extending obliquely upward from the upper end of the lower end portion toward the central side (the direction approaching the axis of rotation of the substrate). The third guide portion is provided to vertically overlap with the second guide portion of the second structural member, and formed to approach the second guide portion while keeping an extremely small clearance when the second structural member and the third structural member most approach each other.

A first lift driving mechanism including a ball screw mechanism or the like is coupled to the first structural member. A second lift driving mechanism including a ball screw mechanism or the like is coupled to the second structural member. A third lift driving mechanism including a ball screw mechanism or the like is coupled to the third structural member. The first to third lift driving mechanisms can individually vertically move the three structural members.

The substrate treatment apparatus having the aforementioned structure can be brought into a state of receiving the treatment solutions with the first guide portion by positioning the upper end portions of the first to third guide portions above the substrate. Further, the substrate treatment apparatus can be brought into a state (a first recovery state) of receiving the treatment solutions with the second guide portion by positioning the upper end of the first guide portion below the substrate while positioning the upper end portions of the second and third guide portions above the substrate. In this first recovery state, a first recovery port opposed to the peripheral edge portion of the substrate is formed between the upper end portion of the first guide portion and the upper end portion of the second guide portion. The treatment solutions entering the first recovery port are guided by the second guide portion and recovered in the inner recovery groove.

In addition, the substrate treatment apparatus can be brought into a state (a second recovery state) of receiving the treatment solutions from the substrate with the third guide portion by positioning the upper end portions of the first and second guide portions below the substrate while positioning the upper end portion of the third guide portion above the substrate. In this second recovery state, a second recovery port opposed to the peripheral edge portion of the substrate is formed between the upper end portion of the second guide portion and the upper end portion of the third guide portion. The treatment solutions entering the second recovery port are guided by the third guide portion and recovered in the outer recovery groove.

The surface of the substrate can be treated with a first chemical solution by supplying the first chemical solution to the surface of the substrate while rotating the substrate with the spin chuck. The first chemical solution supplied to the surface of the substrate receives centrifugal force by the rotation of the substrate, to splash sidewise from the peripheral edge portion of the substrate. When the first recovery port is opposed to the peripheral edge portion of the substrate at this time, the first chemical solution splashing from the peripheral edge portion of the substrate can be recovered. When a second chemical solution is supplied to the surface of the substrate, the second chemical solution splashing from the peripheral edge portion of the substrate can be recovered if the second recovery port is opposed to the peripheral edge portion of the substrate. Thus, the first and second chemical solutions can be separately recovered.

A rinsing treatment of rinsing the surface of the substrate with a rinse solution (a treatment solution) can be performed by supplying the rinse solution to the surface of the substrate while rotating the substrate with the spin chuck. When the first guide portion is opposed to the peripheral edge portion of the substrate at this time, the rinse solution rinsing the surface of the substrate can be collected in the waste liquid groove, and can be discharged from the waste liquid groove through the waste liquid pipe. Thus, the used rinse solution can be prevented from mixing into the recovered first and second chemical solutions.

On the other hand, there is a possibility that a current around the spin chuck is disturbed by the rotation of the substrate and the spin chuck and mists of the first and second chemical solutions fly. If the mists of the first and second chemical solutions leak out of the treatment cup, the inner wall of a treatment chamber and members provided in the treatment chamber are contaminated with the mists of the chemical solutions. When dried in the treatment chamber, the mists of the chemical solutions may form particles floating in the atmosphere, to contaminate subsequently treated substrates. According to U.S. Patent Application Publication No. 2008/078428, therefore, an exhaust port is formed in the bottom surface of the waste liquid groove to perform exhaustion through the exhaust port thereby forming a downward current directed toward the bottom surface of the waste liquid groove around the substrate and preventing flying of the mists of the chemical solutions.

According to this structure, the rinse solution (particularly a mist of the rinse solution) splashing from the substrate is guided to the waste liquid groove along the downward current in the treatment cup when the first guide portion is opposed to the peripheral edge portion of the substrate for the rinse treatment.

However, the exhaust port is formed only in the bottom surface of the waste liquid groove, and hence the mist of the chemical solution (the first or second chemical solution) must be discharged exclusively along the downward current directed toward the bottom surface of the waste liquid groove when the substrate is treated with the chemical solution, and cannot be efficiently eliminated from the periphery of the substrate.

In other words, the first or second recovery port is opposed to the peripheral edge portion of the substrate when the substrate is treated with the chemical solution. Thus, the direction of the chemical solution splashing from the substrate and the direction of the downward current toward the waste liquid groove intersect with each other, and the mist of the chemical solution splashing from the spin chuck cannot properly flow along the downward current but is guided to and remains in the inner portion of the first or second recovery port. Therefore, the mist of the chemical solution may remain in the periphery of the substrate, to exert bad influence on the substrate treatment. Further, the atmosphere containing the mist of the chemical solution may fly to leak out of the treatment cup.

### SUMMARY OF THE INVENTION

Accordingly, an object of the present invention is to provide a substrate treatment apparatus capable of efficiently eliminating a mist of a treatment solution from the periphery of a substrate.

The substrate treatment apparatus according to the present invention includes: a substrate holding unit horizontally holding a substrate; a substrate rotating unit rotating the substrate held by the substrate holding unit around a vertical axis of rotation; a treatment solution supply unit for supplying a treatment solution to the substrate rotated by the substrate rotating unit; an exhaust tub having an exhaust port and storing the substrate holding unit therein; a plurality of guards stored in the exhaust tub and vertically movable independently of one another; an exhaust passage forming unit forming a capture port opposed to the peripheral edge portion of the substrate held by the substrate holding unit for capturing the treatment solution splashing from the substrate while forming an exhaust passage reaching the exhaust port from the capture port by vertically moving the guards; and an exhaust pipe connected to the exhaust port for exhausting the atmosphere in the exhaust tub through the exhaust port.

According to this structure, the exhaust passage reaching the exhaust port from the capture port is formed in the exhaust tub. The treatment solution supplied from the treatment solution supply unit to the substrate rotated by the substrate rotating unit splashes sidewise from the peripheral edge portion of the substrate, and is captured by the capture port opposed to the peripheral edge portion of the substrate. The treatment solution is supplied from the treatment solution supply unit to the substrate, whereby a mist of the treatment solution is formed around the substrate. The atmosphere (treatment solution atmosphere) containing this mist of the treatment solution moves from the capture port to the exhaust port through the exhaust passage when the exhaust pipe is exhausted, to be exhausted through the exhaust pipe.

Therefore, the treatment solution atmosphere in the exhaust tub can be prevented or inhibited from leaking out of the exhaust tub due to the exhaust passage formed in the exhaust tub.

Further, the treatment solution atmosphere is exhausted through the capture port opposed to the peripheral edge portion of the substrate. Therefore, the mist of the treatment solution can be efficiently eliminated from the periphery of the substrate.

Preferably, pressure loss in the exhaust passage formed by the exhaust passage forming unit is rendered smaller than pressure loss in another passage reaching the exhaust port from the peripheral edge portion of the substrate held by the substrate holding unit without through the exhaust passage.

According to this structure, the pressure loss in the exhaust passage is rendered smaller than the pressure loss in another passage reaching the exhaust port without through the exhaust passage. When the exhaust pipe is exhausted, therefore, a current exclusively circulating through the exhaust passage is formed in the exhaust tub. Thus, exhaustion of the treatment solution atmosphere through the capture port can be implemented with a relatively simple structure.

The pressure loss in another passage can be set extremely high, so that the treatment solution atmosphere around the substrate does not enter this passage at all. If a different type of treatment solution (or treatment solution atmosphere) circulates through this passage in this case, the different treatment solutions can be prevented from mixing with or coming into contact with each other by preventing the treatment solution atmosphere from entering this passage.

Preferably, the substrate treatment apparatus further includes a cup for collecting the treatment solution received by each guard correspondingly to each guard, each guard includes a guide portion guiding the treatment solution toward the cup, and the exhaust passage includes a folded passage formed in a clearance between the cup and the guide portion.

According to this structure, the exhaust passage formed in the clearance between the guard and the cup has the folded passage. Therefore, the mist of the treatment solution contained in the atmosphere circulating through the exhaust passage adheres to and is captured by the wall surface of the guard or the wall surface of the cup in the process of circulating through the folded passage. In other words, the treatment solution atmosphere can be gas-liquid separated in the process of circulating through the exhaust passage. Thus, no gas-liquid separator may be provided, whereby the cost can be reduced.

Preferably, the substrate treatment apparatus further includes a treatment chamber storing the exhaust tub, and an inlet for introducing the atmosphere outside the exhaust tub in the treatment chamber into the exhaust tub is formed in the sidewall of the exhaust tub.

According to this structure, the atmosphere in the treatment chamber is introduced into the exhaust tub through the inlet formed in the sidewall of the treatment chamber, and exhausted through the exhaust pipe. Therefore, equipment dedicated to exhaustion of the treatment chamber can be omitted, and the cost can be reduced.

A plurality of such inlets may be formed in the sidewall of the exhaust tub at intervals.

The foregoing and other objects, features and effects of the present invention will become more apparent from the following detailed description of the embodiments with reference to the attached drawings.

### BRIEF DESCRIPTION OF THE DRAWINGS

FIG. 1 is a plan view showing the structure of a substrate treatment apparatus according to an embodiment of the present invention.

FIG. 2 is a sectional view taken along a line A-A in FIG. 1.

FIG. 3 is a block diagram showing the electrical structure of the substrate treatment apparatus shown in FIG. 1.

FIG. 4 is a flow chart for illustrating examples of treatments performed in the substrate treatment apparatus shown in FIG. 1.

FIG. 5A is a partially fragmented schematic sectional view of the substrate treatment apparatus in a hydrofluoric acid treatment.

FIG. 5B is a partially fragmented schematic sectional view of the substrate treatment apparatus in an SC1 treatment and an intermediate rising treatment.

FIG. 5C is a partially fragmented schematic sectional view of the substrate treatment apparatus in an SPM treatment.

FIG. 5D is a partially fragmented schematic sectional view of the substrate treatment apparatus in a final rising treatment.

### DETAILED DESCRIPTION OF PREFERRED EMBODIMENTS

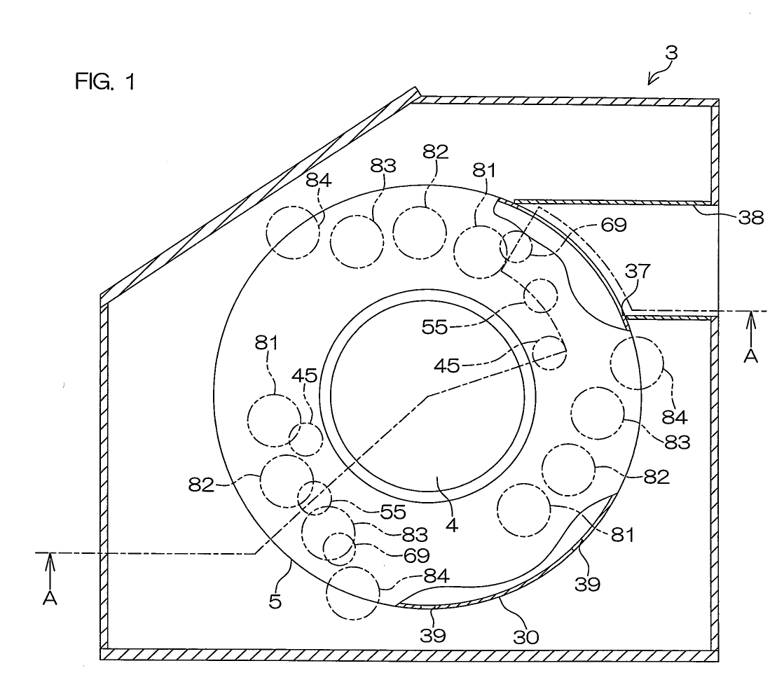

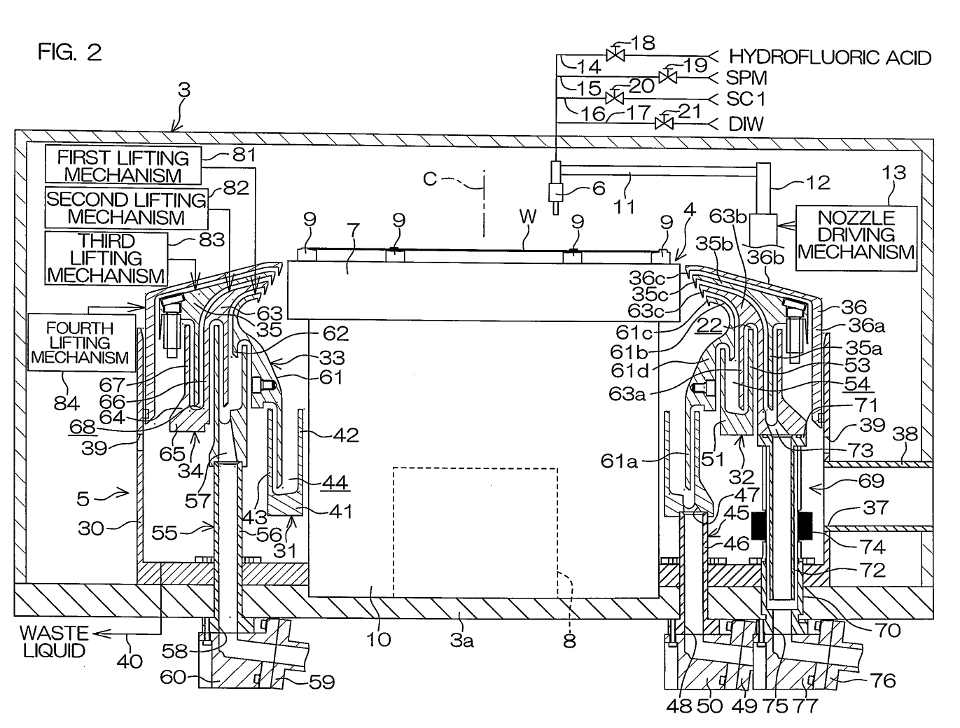

FIG. 1 is a plan view showing the structure of a substrate treatment apparatus according to an embodiment of the present invention. FIG. 2 is a sectional view taken along a line A-A in FIG. 1.

The substrate treatment apparatus is a single treatment apparatus employed for a treatment of removing an unnecessary resist from the surface of a semiconductor wafer (hereinafter simply referred to as “wafer”) W as an example of a substrate after an ion implantation treatment of implanting an impurity into the surface of the wafer W and a dry etching treatment, for example. The substrate treatment apparatus has a treatment chamber 3 surrounded by partitions and provided with a closed space therein. The treatment chamber 3 includes a spin chuck (a substrate holding unit) 4 for generally horizontally holding the wafer W and rotating the wafer W around a generally vertical axis C of rotation (see FIG. 2), a treatment cup 5 storing this spin chuck 4 and a treatment solution nozzle 6 (see FIG. 2) as a treatment solution supply unit for selectively supplying a plurality of treatment solutions to the surface (the upper surface) of the wafer W held by the spin chuck 4. According to this embodiment, chemical solutions (hydrofluoric acid (HF), an SPM (a sulfuric acid/hydrogen peroxide mixture) and an SC1 (an ammonia-hydrogen peroxide mixture)) and DIW (deionized water) as a rinse solution are selectively supplied to the wafer W from the treatment solution nozzle 6.

A fan filter unit (FFU) (not shown) for supplying a downflow of clean air into the treatment chamber 3 is provided on the top face of the treatment chamber 3. This fan filter unit is formed by vertically stacking a fan and a filter, so that the filter purifies a blast formed by the fan and supplies the same into the treatment chamber 3.

The spin chuck 4 includes a discoidal spin base 7 fixed to the upper end of a generally vertically arranged rotating shaft (not shown), a motor (a substrate rotating unit) 8 arranged under the spin base 7 for driving the rotating shaft and a cylindrical cover member 10 surrounding the motor 8. A plurality of (e.g., six) nipping members 9 are arranged on the peripheral edge portion of the upper surface of the spin base 7 at generally regular angular intervals. FIG. 2 shows not a sectional shape but a side elevational shape of the spin chuck 4. The cover member 10 has a lower end fixed to a bottom wall 3a of the treatment chamber 3 and an upper end reaching a portion close to the spin base 7.

The treatment solution nozzle 6 is mounted on the forward end portion of a nozzle arm 11 generally horizontally extending above the spin chuck 4. This nozzle arm 11 is supported by an arm support shaft 12 generally vertically extending on a side portion of the treatment cup 5. A nozzle driving mechanism 13 including a motor (not shown) is coupled to the arm support shaft 12. The nozzle arm 11 can be swung above the spin chuck 4 by inputting torque from the nozzle driving mechanism 13 into the arm support shaft 12 and pivoting the arm support shaft 12. The treatment solution nozzle 6 is retracted to a retracted position on a side of the treatment cup 5 when supplying no treatment solutions, and moves to a position opposed to the upper surface of the wafer W when supplying the treatment solutions.

A hydrofluoric acid supply pipe 14 supplied with hydrofluoric acid from a hydrofluoric acid source, an SPM supply pipe 15 supplied with the SPM from an SPM source, an SC1 supply pipe 16 supplied with the SC1 from an SC1 source and a DIW supply pipe 17 supplied with the DIW of ordinary temperature (25° C., for example) from a DIW source are connected to the treatment solution nozzle 6. A hydrofluoric acid valve 18 for opening/closing the hydrofluoric acid supply pipe 14 is interposed in the middle of the hydrofluoric acid supply pipe 14. An SPM valve 19 for opening/closing the SPM supply pipe 15 is interposed in the middle of the SPM supply pipe 15. An SC1 valve 20 for opening/closing the SC1 supply pipe 16 is interposed in the middle of the SC1 supply pipe 16. A DIW valve 21 for opening/closing the DIW supply pipe 17 is interposed in the middle of the DIW supply pipe 17.

When the hydrofluoric acid valve 18 is opened while the SPM valve 19, the SC1 valve 20 and the DIW valve 21 are closed, the hydrofluoric acid is supplied from the hydrofluoric acid supply pipe 14 to the treatment solution nozzle 6, and discharged from the treatment solution nozzle 6 downward.

When the SPM valve 19 is opened while the hydrofluoric acid valve 18, the SC1 valve 20 and the DIW valve 21 are closed, the SPM is supplied from the SPM supply pipe 15 to the treatment solution nozzle 6, and discharged from the treatment solution nozzle 6 downward.

When the SC1 valve 20 is opened while the hydrofluoric acid valve 18, the SPM valve 19 and the DIW valve 21 are closed, the SC1 is supplied from the SCI supply pipe 16 to the treatment solution nozzle 6, and discharged from the treatment solution nozzle 6 downward.

When the DIW valve 21 is opened while the hydrofluoric acid valve 18, the SPM valve 19 and the SC1 valve 20 are closed, the DIW is supplied from the DIW supply pipe 17 to the treatment solution nozzle 6, and discharged from the treatment solution nozzle 6 downward.

While the treatment solution nozzle 6 is in the form of the so-called scan nozzle scanning a position for supplying the treatment solutions onto the surface of the wafer W by swinging the nozzle arm 11, the treatment solution nozzle 6 may alternatively be fixedly arranged obliquely above the spin chuck 4 or on the axis C of rotation of the wafer W, for supplying the treatment solutions to the surface of the wafer W from above. When a blocking plate proximally opposed to the surface of the wafer W is provided in a drying step described later, a treatment solution supply port may be formed in the central portion of the blocking plate so that the treatment solutions are supplied to the surface of the wafer W from the treatment solution supply port.

The treatment cup 5 includes a bottomed cylindrical exhaust tub 30 stored in the treatment chamber 3 as well as a first cup 31 and a second cup 32 fixedly stored in the exhaust tub 30. The treatment cup 5 further includes a first guard 33, a second guard 34, a third guard 35 and a fourth guard 36 stored in the exhaust tub 30 and vertically movable independently of one another. According to this embodiment, the first cup 31 and the second cup 32 do not integrally move with the first to fourth guards 33 to 36, but are fixed in the exhaust tub 30. Therefore, the weights of the members to be vertically moved can be reduced, and loads on first to fourth lifting mechanisms 81 to 84 for vertically moving the first to fourth guards 33 to 36 respectively can be reduced.

An exhaust port 37 passing through the sidewall of the exhaust tub 30 is formed in the sidewall of the exhaust tub 30. An exhaust pipe 38 exhausting the atmosphere in the exhaust tub 30 through the exhaust port 37 is connected to the exhaust port 37. Inlets 39 for introducing the atmosphere in the remaining portion of the treatment chamber 3 into the exhaust tub 30 are further formed in the sidewall of the exhaust tub 30. The plurality of inlets 39 passing through the sidewall of the exhaust tub 30 are arranged at intervals in the peripheral direction of the exhaust tub 30.

A waste liquid pipe 40 is connected to the bottom portion of the exhaust tub 30. The treatment solutions collected in the bottom portion of the exhaust tub 30 are guided to waste liquid treating equipment through the waste liquid pipe 40.

The first cup 31, surrounding the periphery of the spin chuck 4, has a generally rotation-symmetrical shape with respect to the axis C of rotation of the wafer W with the spin chuck 4. This first cup 31 integrally includes a bottom portion 41 annular in plan view, a cylindrical inner wall portion 42 uprighted from the inner peripheral edge portion of the bottom portion 41 and a cylindrical outer wall portion 43 uprighted from the outer peripheral edge portion of the bottom portion 41. The bottom portion 41, the inner wall portion 42 and the outer wall portion 43 have U-shaped sections. The bottom portion 41, the inner wall portion 42 and the outer wall portion 43 partition a waste liquid groove 44 for collecting and discarding the treatment solutions (the SC1 and the DIW) used for treating the wafer w. Waste liquid mechanisms 45 for guiding the treatment solutions collected in the waste liquid groove 44 to exhaust equipment (not shown) are connected to the lowermost part of the bottom portion of the waste liquid groove 44. Two such waste liquid mechanisms 45 are provided at a regular interval in relation to the peripheral direction of the waste liquid groove 44, as shown in FIG. 1.

Each waste liquid mechanism 45 includes a fixed cylindrical member 46 fixed to the lower surface of the bottom wall 3a of the treatment chamber 3 and inserted into the bottom portion of the exhaust tub 30 and the bottom wall 3a of the treatment chamber 3 to extend upward and a communication hole 47 communicatively connecting the fixed cylindrical member 46 and the waste liquid groove 44 with each other. The fixed cylindrical member 46 holds the first cup 31, and a lower opening of the fixed cylindrical member 46 forms a connection port 48. A joint 50 connected to a waste liquid pipe 49 extending from a waste liquid tank (not shown) is connected to the connection port 48. The treatment solutions (the SC1 and the DIW) collected in the waste liquid groove 44 are guided to the waste liquid tank (not shown) through the communication hole 47, the fixed cylindrical member 46, the joint 50 and the waste liquid pipe 49.

The second cup 32, surrounding the spin chuck 4 outside the first cup 31, has a generally rotation-symmetrical shape with respect to the axis C of rotation of the wafer W with the spin chuck 4. This second cup 32 integrally includes a bottom portion 51 annular in plan view, a cylindrical inner wall portion 52 uprighted from the inner peripheral edge of the bottom portion 51 and a cylindrical outer wall portion 53 uprighted from the outer peripheral edge of the bottom portion 51. The bottom portion 51, the inner wall portion 52 and the outer wall portion 53 have U-shaped sections. The bottom portion 51, the inner wall portion 52 and the outer wall portion 53 partition an inner recovery groove 54 for collecting and recovering the treatment solution (the SPM, for example) used for treating the wafer W. First recovery mechanisms 55 for guiding the treatment solution collected in the inner recovery groove 54 to recovery equipment (not shown) are connected to the lowermost part of the bottom portion of the inner recovery groove 54. Two such recovery mechanisms 55 are provided at a regular interval in relation to the peripheral direction of the inner recovery groove 54, as shown in FIG. 1.

Each first recovery mechanism 55 includes a fixed cylindrical member 56 fixed to the lower surface of the bottom wall 3a of the treatment chamber 3 and inserted into the bottom portion of the exhaust tub 30 and the bottom wall 3a of the treatment chamber 3 to extend upward and a communication hole 57 communicatively connecting the fixed cylindrical member 56 and the inner recovery groove 54 with each other. The fixed cylindrical member 56 holds the second cup 32, and a lower opening of the fixed cylindrical member 56 forms a connection port 58. A joint 60 connected to a first recovery pipe 59 extending from a recovery tank (not shown) is connected to the connection port 58. The treatment solution collected in the inner recovery groove 54 is recovered in the recovery tank through the communication hole 57, the fixed cylindrical member 56, the joint 60 and the first recovery pipe 59.

The first guard 33, surrounding the periphery of the spin chuck 4, has a generally rotation-symmetrical shape with respect to the axis C of rotation of the wafer W with the spin chuck 4. This first guard 33 includes a generally cylindrical first guide portion 61 and a cylindrical treatment solution separation wall 62 coupled to the first guide portion 61.

The first guide portion 61 has a cylindrical lower end portion 61a surrounding the periphery of the spin chuck 4, a middle stage portion 61d extending obliquely upward from the upper end of the lower end portion 61a outward in the radial direction (a direction separating from the axis C of rotation of the wafer W), an upper end portion 61b extending obliquely upward from the upper end of the middle stage portion 61d toward a central side (a direction approaching the axis C of rotation of the wafer W) while drawing a smooth arc and a folded portion 61c formed by folding the forward end portion of the upper end portion 61b downward. The treatment solution separation wall 62 is suspended downward from the outer peripheral edge portion of the middle stage portion 61d, and positioned on the inner recovery groove 54 of the second cup 32.

The lower end portion 61a of the first guide portion 61, positioned on the waste liquid groove 44, is formed in such a length that the same is stored in the waste liquid groove 44 of the first cup 31 while keeping an extremely small clearance between the bottom portion 41 and the outer wall portion 43 when the first guard 33 most approaches the first cup 31 (the state shown in FIG. 2).

The second guard 34, surrounding the periphery of the first guard 33, has a generally rotation-symmetrical shape with respect to the axis C of rotation of the wafer W with the spin chuck 4. This second guard 34 integrally includes a second guide portion 63 and a cup portion 64.

The second guide portion 63 has a cylindrical lower end portion 63a coaxial with the lower end portion 61a of the first guide portion 61, an upper end portion 63b extending obliquely upward from the upper end of the lower end portion 63a toward the central side (the direction approaching the axis C of rotation of the wafer W) while drawing a smooth arc and a folded portion 63c formed by folding the forward end portion of the upper end portion 63b downward outside the first guide portion 61 of the first guard 33. The lower end portion 63a is positioned on the inner recovery groove 54. The lower end portion 63a is stored in the inner recovery groove 54 while keeping a clearance between the same and the bottom portion 51 and the outer wall portion 53 of the second cup 32 as well as the treatment solution separation wall 62 when the second guard 34 and the second cup 32 most approach each other. On the other hand, the upper end portion 63b is provided to vertically overlap with the upper end portion 61b of the first guide portion 61 of the first guard 33. The upper end portion 63b approaches the upper end portion 61b of the first guide portion 61 while keeping an extremely small clearance when the first guard 33 and the second guard 34 most approach each other.

The second guide portion 63 includes a folded portion 63c formed by folding the forward end of the upper end portion 63b generally vertically downward. The folded portion 63c is formed to horizontally overlap with the upper end portion 61b of the first guide portion 61 when the first guard 33 and the second guard 34 most approach each other. The thickness of the upper end portion 63b of the second guide portion 63 is increased downward.

The cup portion 64 includes a bottom portion 65 annular in plan view, a cylindrical inner wall portion 66 uprighted from the inner peripheral edge portion of the bottom portion 65 and coupled to the second guide portion 63 and a cylindrical outer wall portion 67 uprighted from the outer peripheral edge portion of the bottom portion 65. The bottom portion 65, the inner wall portion 66 and the outer wall portion 67 have U-shaped sections. The bottom portion 65, the inner wall portion 66 and the outer wall portion 67 partition an outer recovery groove 68 for collecting and recovering the treatment solution (the hydrofluoric acid, for example) used for treating the wafer W. The inner wall portion 66 of the cup portion 64 is coupled to the outer peripheral edge portion of the upper end portion 63b of the second guide portion 63.

Second recovery mechanisms 69 for recovering the treatment solution collected in the outer recovery groove 68 in the recovery tank (not shown) are connected to the outer recovery groove 68. Two such second recovery mechanisms 69 are provided at a regular interval in relation to the peripheral direction of the outer recovery groove 68, as shown in FIG. 1.

Each second recovery mechanism 69 includes a fixed cylindrical member 70 fixed to the lower surface of the bottom wall 3a of the treatment chamber 3 and inserted into the bottom portion of the exhaust tub 30 and the bottom wall 3a of the treatment chamber 3 to extend upward, an annular holding member 71 fixed to the bottom portion 65 of the cup portion 64 of the second guard 34, a movable cylindrical member 72 having an upper end portion held by the holding member 71 and a lower end portion inserted into the fixed cylindrical member 70, a communication hole 73 communicatively connecting the movable cylindrical member 62 and the outer recovery groove 68 with each other, and a bellows 74 having an upper end portion fixed to the holding member 71 and a lower end portion fixed to the fixed cylindrical member 70 and covering the outer periphery of the movable cylindrical member 72. A lower opening of the fixed cylindrical member 70 forms a connection port 75. A joint 77 connected to a second recovery pipe 76 extending from the recovery tank is connected to the connection port 75. The treatment solution collected in the outer recovery groove 68 is recovered in the recovery tank through the communication hole 73, the movable cylindrical member 72, the fixed cylindrical member 70, the joint 77 and the second recovery pipe 76.

The outer peripheral edge portion of the upper end portion 63b, the lower end portion 63a and the inner wall portion 66 have inverted U-shaped sections. The outer peripheral edge portion of the upper end portion 63b, the lower end portion 63a and the inner wall portion 66 partition a storage groove 22 for storing the outer wall portion 53 of the second cup 32. The storage groove 22 is positioned on the outer wall portion 53 of the second cup 32. The storage groove 22 is formed in a depth for storing the outer wall portion 53 in the storage groove 22 while keeping an extremely small clearance between the same and the outer peripheral edge portion of the upper end portion 63a, the lower end portion 63a and the inner wall portion 66 when the second guard 34 most approaches the second cup 32 (the state shown in FIG. 2).

The third guard 35, surrounding the periphery of the spin chuck 4 outside the second guide portion 63 of the second guard 34, has a generally rotation-symmetrical shape with respect to the axis C of rotation of the wafer W with the spin chuck 4. This third guard 35 has a cylindrical lower end portion 35a coaxial with the lower end portion 63a of the second guide portion 63, an upper end portion 35b extending obliquely upward from the upper end of the lower end portion 35a toward the central side (the direction approaching the axis C of rotation of the wafer W) while drawing a smooth arc and a folded portion 35c formed by folding the forward end portion of the upper end portion 35b generally vertically downward.

The lower end portion 35a is positioned on the outer recovery groove 68, and formed in such a length that the same is stored in the outer recovery groove 68 while keeping an extremely small clearance between the same and the bottom portion 65, the inner wall portion 66 and the outer wall portion 67 of the cup portion 64 of the second guard 34 when the second guard 34 and the third guard 35 most approach each other.

The upper end portion 35b is provided to vertically overlap with the upper end portion 63b of the second guide portion 63 of the second guard 34, and formed to approach the upper end portion 63b of the second guide portion 63 while keeping an extremely small clearance when the second guard 34 and the third guard 35 most approach each other.

The folded portion 35c is formed to horizontally overlap with the upper end portion 63b of the second guide portion 63 when the second guard 34 and the third guard 35 most approach each other.

The fourth guard 36, surrounding the periphery of the spin chuck 4 outside the third guard 35, has a generally rotation-symmetrical shape with respect to the axis C of rotation of the wafer W with the spin chuck 4. The fourth guard 36 is vertically movably held on the sidewall of the exhaust tub 30. This fourth guard 36 has a cylindrical lower end portion 36a coaxial with the lower end portion 35a of the third guard 35, an upper end portion 36b extending obliquely upward from the upper end of the lower end portion 36a toward the central side (the direction approaching the axis C of rotation of the wafer W) and a folded portion 36c formed by folding the forward end portion of the upper end portion 36b generally vertically downward.

The upper end portion 36b is provided to vertically overlap with the upper end portion 35b of the third guard 35, and formed to approach the upper end portion 35b of the third guard 35 while keeping an extremely small clearance when the third guard 35 and the fourth guard 36 most approach each other.

The folded portion 36c is formed to horizontally overlap with the upper end portion 35b of the third guard 35 when the third guard 35 and the fourth guard 36 most approach each other.

The substrate treatment apparatus further includes the first lifting mechanisms (exhaust passage forming units) 81 for vertically moving the first guard 33, the second lifting mechanisms (exhaust passage forming units) 82 for vertically moving the second guard 34, the third lifting mechanisms (exhaust passage forming units) 83 for vertically moving the third guard 35 and the fourth lifting mechanisms (exhaust passage forming units) 84 for vertically moving the fourth guard 36. A lifting mechanism (a ball screw mechanism, for example) driven by a motor or a lifting mechanism driven by a cylinder is employed for each of the lifting mechanisms 81, 82, 83 and 84. Three sets of such lifting mechanisms 81, 82, 83 and 84 are provided at regular intervals with respect to the peripheral direction of the exhaust tub 30, as shown in FIG. 1.

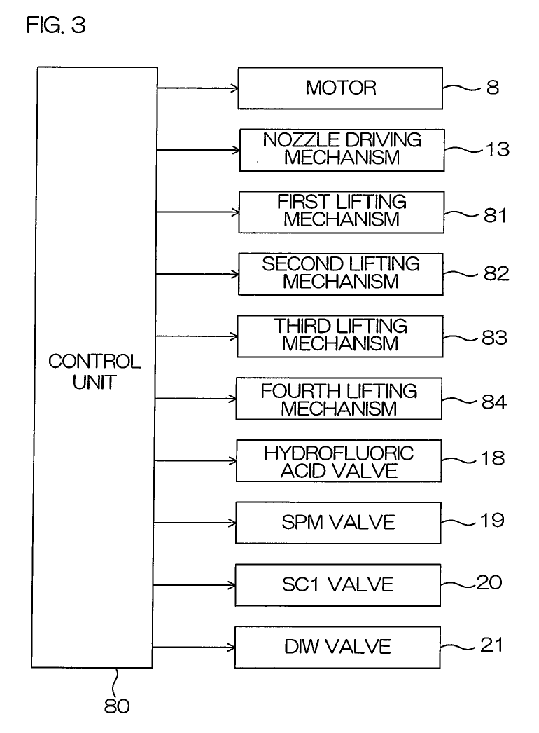

FIG. 3 is a block diagram showing the electrical structure of the substrate treatment apparatus shown in FIG. 1.

The substrate treatment apparatus includes a control unit 80 including a microcomputer. The motor 8, the nozzle driving mechanism 13, the first lifting mechanisms 81, the second lifting mechanisms 82, the third lifting mechanisms 83, the fourth lifting mechanisms 84, the hydrofluoric acid valve 18, the SPM valve 19, the SC1 valve 20 and the DIW valve 21 are connected to the control unit 80 as objects to be controlled.

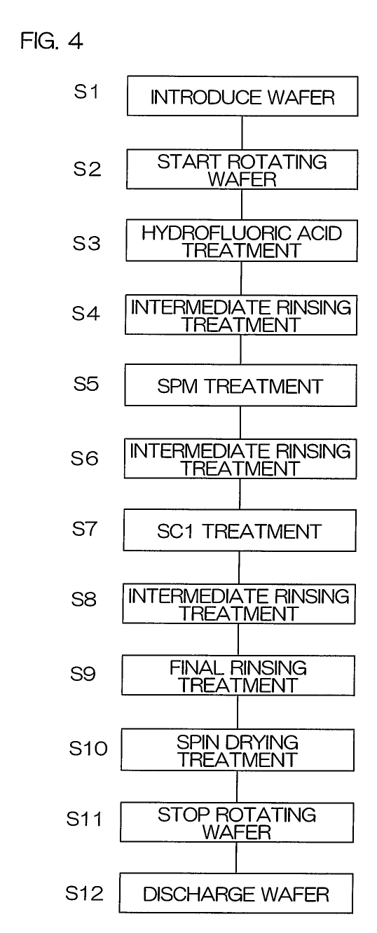

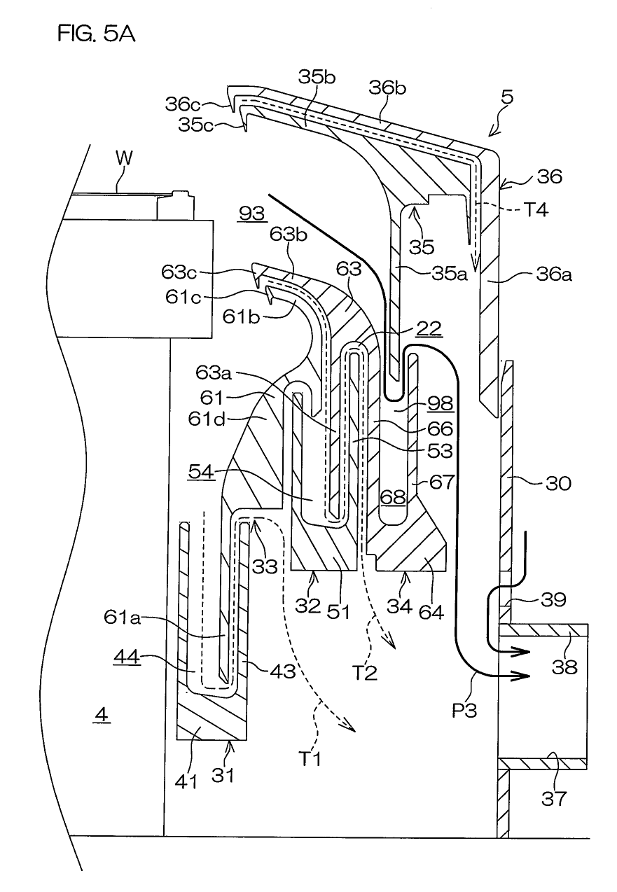

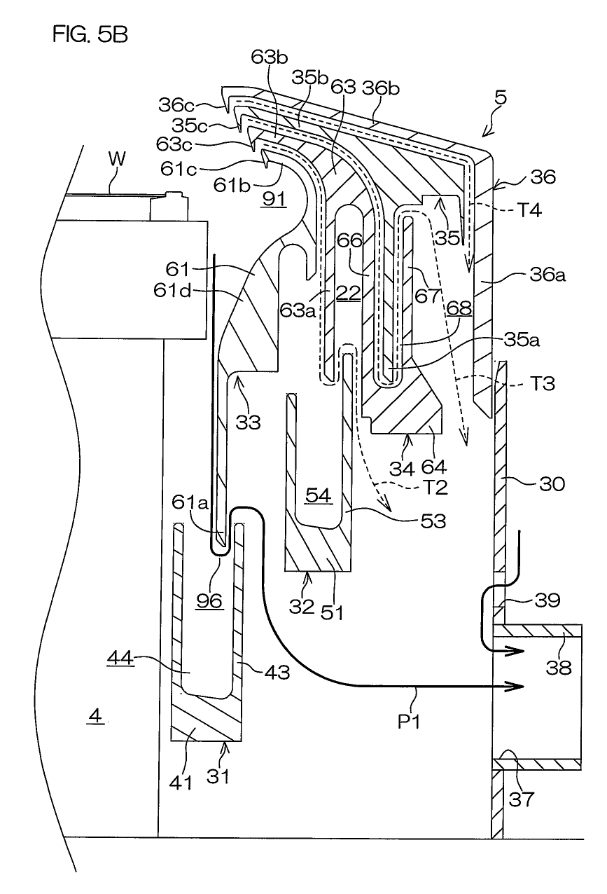

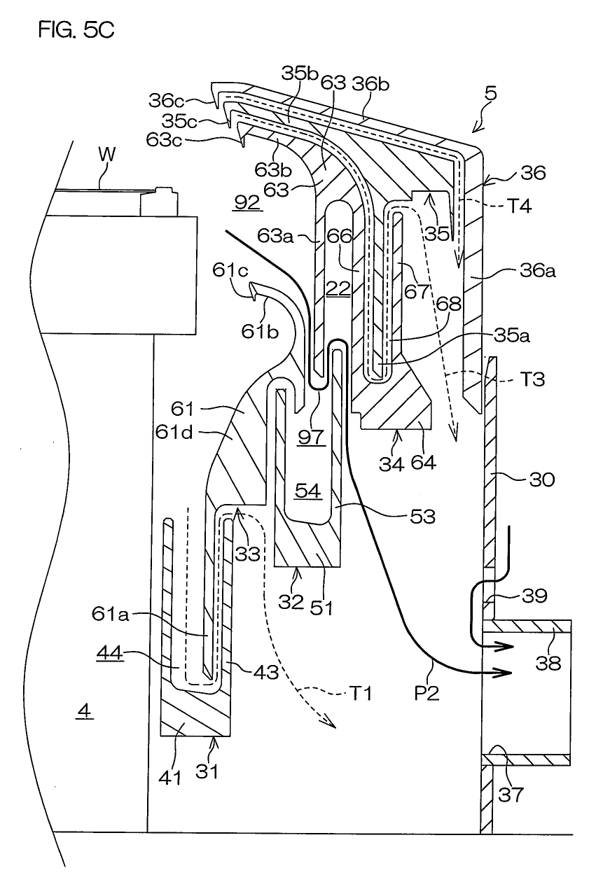

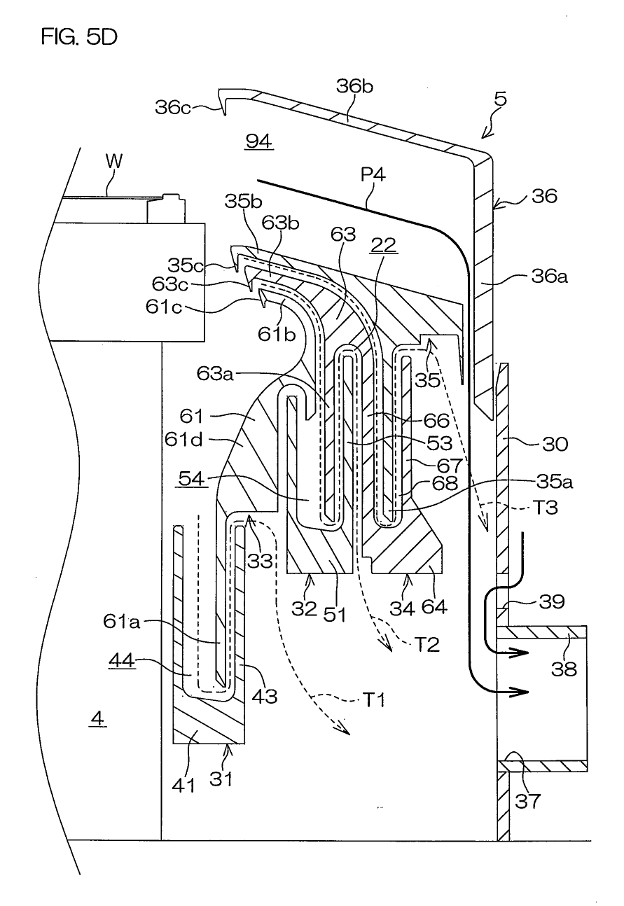

FIG. 4 is a flow chart for illustrating examples of treatments performed in the substrate treatment apparatus shown in FIG. 1. FIGS. 5A to 5D are partially fragmented schematic sectional views of the substrate treatment apparatus in the process of treating the wafer W.

While the substrate treatment apparatus treats the wafer W, the exhaust pipe 38 is forcibly exhausted by the exhaust treatment equipment (not shown). Further, the fan filter unit supplies clean air into the treatment chamber 3. Therefore, a downflow of the clean air flowing downward from above is formed in the treatment chamber 3, introduced into the treatment cup 5 through a clearance between the spin chuck 4 and the inner edge portion of the treatment cup 5 (the upper end portion 36b of the fourth guard 36), and guided to a side portion of the wafer W held by the spin chuck 4.

The clean air moving downward in the treatment chamber 3 to a portion around the bottom wall 3a is introduced into the exhaust tub 30 through the inlet 39 formed in the sidewall of the exhaust tub 30, and exhausted from the exhaust pipe 38 through the exhaust port 37.

In a resist removing treatment, a transport robot (not shown) transports the wafer W subjected to an ion implantation treatment into the treatment chamber 3 (step S1). This wafer W is not ashed with respect to a resist employed as a mask for the ion implantation, and the resist is present on the surface thereof. The wafer W is held by the spin chuck 4 while directing this surface upward. Before this transportation of the wafer W, the first to fourth guards 33, 34, 35 and 36 are moved down to lower positions (lowermost positions) as shown in FIG. 2, in order not to hinder the transportation. Therefore, all of the upper end portion 61b of the first guide portion 61 of the first guard 33, the upper end portion 63b of the second guide portion 63 of the second guard 34, the upper end portion 35b of the third guard 35 and the upper end portion 36b of the fourth guard 36 are located below the position of the wafer W held by the spin chuck 4.

When the wafer W is held by the spin chuck 4, the control unit 80 controls the motor 8 to start rotating the wafer W (rotating the spin base 7) with the spin chuck 4 (step S2). Further, the control unit 80 controls the third and fourth lifting mechanisms 83 and 84 for moving only the third and fourth guards 35 and 36 to upper positions (uppermost positions) and arranging the upper end portions 35b and 36b of the third and fourth guards 35 and 36 above the wafer W held by the spin chuck 4. Thus, an opening (a second recovery port) 93 opposed to the peripheral edge portion of the wafer W is formed between the upper end portion 63b of the second guide portion 63 and the upper end portion 35b of the third guard 35 (see FIG. 5A). In addition, the nozzle driving mechanism 13 is controlled to pivot the nozzle arm 11, for moving the treatment solution nozzle 6 from the retracted position on the side of the spin chuck 4 to a position above the wafer W.

When the second recovery port 93 is formed between the upper end portion 63b of the second guide portion 63 and the upper end portion 35b of the third guard 35 (a second recovery state), the first guard 33 most approaches the first cup 31. Thus, the lower end portion 61a of the first guide portion 61 extends up to a portion remarkably close to the bottom portion 41 of the first cup 31 while keeping an extremely small clearance between the same and the outer wall portion 43 of the first cup 31. Therefore, a first passage T1 reaching the exhaust port 37 through a space between the lower end portion 61a of the first guide portion 61 and the waste liquid groove 44 and through the exhaust tub 30 has relatively large pressure loss.

In this second recovery state, the first and second guards 33 and 34 most approach the second cup 32. Thus, the first and second guards 33 and 34 approach each other while keeping an extremely small clearance between the upper end portion 61b of the first guide portion 61 of the first guard 33 and the upper end portion 63b of the second guide portion 63 of the second guard 34, the folded portion 63c of the second guide portion 63 horizontally overlaps with the upper end portion 61b of the first guide portion 61, and the outer wall portion 53 of the second cup 32 extends up to a portion remarkably close to the outer peripheral edge portion of the upper end portion 63b corresponding to the top portion of the storage groove 22 while keeping an extremely small clearance between the same and the lower end portion 63a of the second guide portion 63 and the inner wall portion 66 of the cup portion 64. Therefore, a second passage T2 reaching the exhaust port 37 through the clearance between the upper end portion 61b of the first guide portion 61 and the upper end portion 63b of the second guide portion 63 and a space between the lower end portion 63a of the second guide portion 63 and the inner recovery groove 54 and through the exhaust tub 30 has relatively large pressure loss.

In this second recovery state, further, the third guard 35 and the fourth guard 36 most approach each other, whereby the third and fourth guards 35 and 36 approach each other while keeping an extremely small clearance between the upper end portions 35b and 36b thereof and the folded portion 36c of the fourth guard 36 horizontally overlaps with the upper end portion 35b of the third guard 35. Therefore, a fourth passage T4 reaching the exhaust port 37 through a space between the upper end portion 35b of the third guard 35 and the upper end portion 36b of the fourth guard 36 and through the exhaust tub 30 has relatively large pressure loss.

On the other hand, a third exhaust passage P3 reaching the exhaust port 37 through a space between the upper end portion 63b of the second guide portion 63 and the upper end portion 35b of the third guard 35 and a space between the lower end portion 35a of the third guard 35 and the outer recovery groove 68 and through the exhaust tub 30 from the second recovery port 93 is formed in the exhaust tub 30. The depth of the lower end portion 35a of the third guard 35 entering the outer recovery groove 68 is small, and hence the third exhaust passage P3 has remarkably small pressure loss as compared with the remaining passages T1, T2 and T4. When the exhaust pipe 38 is forcibly exhausted, therefore, the downflow of the clean air introduced into the treatment cup 5 from a space between the spin chuck 4 and the inner edge portion of the treatment cup 5 (the upper end portion 36b of the fourth guard 36) exclusively circulates through the third exhaust passage P3, and is guided to the exhaust port 37. Therefore, a current flowing into the third exhaust passage P3 through the second recovery port 93 is formed from the periphery of the wafer W held by the spin chuck 4.

When the rotational speed of the wafer W reaches 1500 rpm, the control unit 80 opens the hydrofluoric acid valve 18, and the treatment solution nozzle 6 discharges the hydrofluoric acid toward the surface of the rotated wafer W (S3: a hydrofluoric acid treatment).

In this hydrofluoric acid treatment, the control unit 80 controls the nozzle driving mechanism 13, to swing the nozzle arm 11 in a prescribed angular range. Thus, a supply position on the surface of the wafer W to which the hydrofluoric acid from the treatment solution nozzle 6 is guided reciprocates in the range reaching the peripheral edge portion of the wafer W from the rotation center of the wafer W while drawing an arcuate locus intersecting with the rotational direction of the wafer W. The hydrofluoric acid supplied to the surface of the wafer W spreads on the overall region of the surface of the wafer W. Thus, the hydrofluoric acid is uniformly supplied to the overall region of the surface of the wafer W. A natural oxide film etc. formed on the surface of the wafer W can be removed by the chemical ability of the hydrofluoric acid supplied from the treatment solution nozzle 6 to the surface of the wafer W. When the hydrofluoric acid is supplied to the surface of the wafer W, a mist of the hydrofluoric acid is formed. The hydrofluoric acid supplied to the surface of the wafer W splashes sidewise from the peripheral edge portion of the wafer W.

The hydrofluoric acid drained from the peripheral edge portion of the wafer W to splash sidewise is captured by the second recovery port 93, flows down along the inner surface of the third guard 35, is collected in the outer recovery groove 68, and recovered in the recovery tank from the outer recovery groove 68 through the second recovery mechanism 69.

At this time, the first and second guards 33 and 34 approach each other while keeping the extremely small clearance between the upper end portion 61b of the first guide portion 61 of the first guard 33 and the upper end portion 63b of the second guide portion 63 of the second guard 34 and the folded portion 63c of the second guide portion 63 horizontally overlaps with the upper end portion 61b of the first guide portion 61, whereby the hydrofluoric acid is prevented from entering a space between the first guide portion 61 and the second guide portion 63.

Further, the third and fourth guards 35 and 36 approach each other while keeping an extremely small space between the upper end portion 35b of the third guard 35 and the upper end portion 36b of the fourth guard 36 and the folded portion 35c of the third guard 35 horizontally overlaps with the upper end portion 36b of the fourth guard 36, whereby the hydrofluoric acid is prevented from entering a space between the third guard 35 and the fourth guard 36.

The atmosphere containing the mist of the hydrofluoric acid is exhausted to the exhaust port 37 from the second recovery port 93 through the third exhaust passage P3. The atmosphere containing the mist of the hydrofluoric acid in the periphery of the wafer W is exhausted through the second recovery port 93 opposed to the peripheral edge portion of the wafer W, whereby the mist of the hydrofluoric acid can be efficiently eliminated from the periphery of the wafer W.

At this time, the lower end portion 35a of the third guard 35 enters the outer recovery groove 68, and hence the third exhaust passage P3 has a third folded passage 98 folded from a vertically downwardly directed state to a vertically upwardly directed state in this portion. In the process of circulating through the third folded passage 98, the mist of the hydrofluoric acid contained in the atmosphere adheres to and is captured by the lower end portion 35a of the third guard 35 or the outer wall portion 67 of the cup portion 64. Therefore, the atmosphere containing the mist of the hydrofluoric acid can be gas-liquid separated in the process of circulating through the third exhaust passage P3. The hydrofluoric acid captured by the lower end portion 35a or the outer wall portion 67 is guided to the second recovery mechanism 69 through the outer recovery groove 68.

When a prescribed hydrofluoric acid treatment time elapses from the start of the supply of the hydrofluoric acid to the wafer W, the control unit 80 closes the hydrofluoric acid valve 18, to stop supplying the hydrofluoric acid from the treatment solution nozzle 6. The control unit 80 further drives the first and second lifting mechanisms 81 and 82 to move the first and second guards 33 and 34 to the upper positions, thereby arranging the upper end portion 61b of the first guide portion 61, the upper end portion 63b of the second guide portion 63, the upper end portion 35b of the third guard 35 and the upper end portion 36b of the fourth guard 36 above the wafer W held by the spin chuck 4. Thus, an opening (a first waste port) 91 opposed to the peripheral edge portion of the wafer W is formed between the upper end portion 61b and the lower end portion 61a of the first guide portion 61 (see FIG. 5B). The control unit 80 drives the nozzle driving mechanism 13 to stop swinging the nozzle arm 11, whereby the treatment solution nozzle 6 is stopped on the wafer W.

When the first waste liquid port 91 is formed between the upper end portion 61b and the lower end portion 61a of the first guide portion 61 (a first waste liquid discharge state), the first and second guards 33 and 34 most approach each other. Thus, the first and second guards 33 and 34 approach each other while keeping the extremely small clearance between the upper end portion 61b of the first guide portion 61 of the first guard 33 and the upper end portion 63b of the second guide portion 63 of the second guard 34, and the folded portion 63c of the second guide portion 63 horizontally overlaps with the upper end portion 61b of the first guide portion 61. Therefore, the second passage T2 reaching the exhaust port 37 through the clearance between the upper end portion 61b of the first guide portion 61 and the upper end portion 63b of the second guide portion 63 and the space between the lower end portion 63a of the second guide portion 63 and the inner recovery groove 54 and through the exhaust tub 30 has relatively large pressure loss.

In the first waste liquid discharge state, the second and third guards 34 and 35 most approach each other. Thus, the second guide portion 63 and the third guard 35 approach each other while keeping an extremely small clearance between the upper end portions 63b and 35b thereof, the folded portion 35c of the third guard 35 horizontally overlaps with the upper end portion 63b of the second guide portion 63, and the lower end portion 35a of the third guard 35 extends up to a portion remarkably close to the bottom portion 65 of the cup portion 64 while keeping an extremely small clearance between the same and the inner wall portion 66 and the outer wall portion 67 of the cup portion 64. Therefore, a third passage T3 reaching the exhaust port 37 through the space between the upper end portion 63b of the second guide portion 63 and the upper end portion 35b of the third guard 35 and the space between the lower end portion 35a of the third guard 35 and the outer recovery groove 68 and through the exhaust tub 30 has relatively large pressure loss.

In the first waste liquid discharge state, the third and fourth guards 35 and 36 most approach each other, and hence the fourth passage T4 reaching the exhaust port 37 through the space between the upper end portion 35b of the third guard 35 and the upper end portion 36b of the fourth guard 36 and through the exhaust tub 30 has relatively large pressure loss, as hereinabove described.

On the other hand, a first exhaust passage P1 reaching the exhaust port 37 from the first waste liquid port 91 through the space between the lower end portion 61a of the first guide portion 61 and the waste liquid groove 44 is formed in the exhaust tub 30. The depth of the lower end portion 61a of the first guide portion 61 entering the waste liquid groove 44 is small, and hence the first exhaust passage P1 has remarkably small pressure loss as compared with the remaining passages T2, T3 and T4. When the exhaust pipe 38 is forcibly exhausted, therefore, the downflow of the clean air introduced into the treatment cup 5 from the space between the spin chuck 4 and the inner edge portion of the treatment cup 5 (the upper end portion 36b of the fourth guard 36) exclusively circulates through the first exhaust passage P1 and is guided to the exhaust port 37. Thus, a current flowing into the first exhaust passage P1 through the first waste liquid port 91 is formed from the periphery of the wafer W held by the spin chuck 4.

After the first waste liquid port 91 is formed to be opposed to the peripheral edge portion of the wafer W, the control unit 80 opens the DIW valve 21 while continuously rotating the wafer W. Thus, the DIW is discharged from the treatment solution nozzle 6 toward the central portion of the surface of the rotated wafer W (S4: an intermediate rinsing treatment). In this intermediate rinsing treatment, the DIW supplied onto the surface of the wafer W spreads on the overall region of the surface of the wafer W, to wash out the hydrofluoric acid adhering to the surface of the wafer W. The DIW containing the hydrofluoric acid is drained due to the rotation of the wafer W, and splashes sidewise from the peripheral edge portion thereof. The DIW (the DIW containing the hydrofluoric acid) drained from the peripheral edge portion of the wafer W to splash sidewise is captured by the inner surface of the first guide portion 61 of the first guard 33. The DIW flows down along the inner surface of the first guard 33, is collected in the waste liquid groove 44 and guided to the waste liquid treating equipment from the waste liquid groove 44 through the waste liquid mechanisms 45.

At this time, the first to fourth guards 33, 34, 35 and 36 approach one another while keeping extremely small clearances between the upper end portions 61b, 63b, 35b and 36b thereof, the folded portion 36c of the fourth guard 36 horizontally overlaps with the upper end portion 35b of the third guard 35, the folded portion 35c of the third guard 35 horizontally overlaps with the upper end portion 63b of the second guide portion 63 and the folded portion 63c of the second guide portion 63 horizontally overlaps with the upper end portion 61b of the first guide portion 61, whereby the DIW is prevented from entering the space between the first guide portion 61 and the second guide portion 63, a space between the second guide portion 63 and the third guard 35 and the space between the third guard 35 and the fourth guard 36.

In this intermediate rinsing treatment, the mist of the hydrofluoric acid may remain in the periphery of the wafer W. The atmosphere containing the mist of the DIW and the mist of the hydrofluoric acid is exhausted to the exhaust port 37 from the first waste liquid port 91 through the first exhaust passage P1.

At this time, the lower end portion 61a of the first guide portion 61 enters the waste liquid groove 44, whereby the first exhaust passage P1 has a first folded passage 96 folded from a vertically downwardly directed state to a vertically upwardly directed state in this portion. In the process of circulating through the first folded passage 96, the mists of the DIW and the hydrofluoric acid contained in the atmosphere adhere to and are captured by the lower end portion 61a of the first guide portion 61 or the outer wall portion 43 of the first cup 31. Therefore, the atmosphere containing the mists of the DIW and the hydrofluoric acid can be gas-liquid separated in the process of circulating through the first exhaust passage P1. The DIW captured by the lower end portion 61a or the outer wall portion 43 of the first cup 31 is guided to the waste liquid mechanisms 45 through the waste liquid groove 44.

When a prescribed intermediate rinsing time elapses from the start of the supply of the DIW to the wafer W, the control unit 80 closes the DIW valve 21, to stop supplying the DIW from the treatment solution nozzle 6. The control unit 80 further drives the first lifting mechanisms 81 to move only the first guard 33 to the lower position, thereby arranging the upper end portion 61b of the first guide portion 61 of the first guard 33 below the wafer W held by the spin chuck 4. Thus, an opening (a first recovery port) 92 opposed to the peripheral edge portion of the wafer W is formed between the upper end portion 61b of the first guide portion 61 and the upper end portion 63b of the second guide portion 63 (see FIG. 5C).

When the first recovery port 92 is formed between the upper end portion 61b of the first guide portion 61 and the upper end portion 63b of the second guide portion 63 (a first recovery state), the first guard 33 most approaches the first cup 31. Therefore, the first passage T1 reaching the exhaust port 37 through the space between the lower end portion 61a of the first guide portion 61 and the waste liquid groove 44 and through the exhaust tub 30 has relatively large pressure loss, as hereinabove described.

In this first recovery state, the second and third guards 34 and 35 most approach each other. Therefore, the third passage T3 reaching the exhaust port 37 through the space between the upper end portion 63b of the second guide portion 63 and the upper end portion 35b of the third guard 35 and the space between the lower end portion 35a of the third guard 35 and the outer recovery groove 68 and through the exhaust tub 30 has relatively large pressure loss, as hereinabove described.

In this first recovery state, further, the third and fourth guards 35 and 36 most approach each other, whereby the fourth passage T4 reaching the exhaust port 37 through the space between the upper end portion 35b of the third guard 35 and the upper end portion 36b of the fourth guard 36 and through the exhaust tub 30 has relatively large pressure loss, as hereinabove described.

On the other hand, a second exhaust passage P2 reaching the exhaust port 37 through the clearance between the upper end portion 61b of the first guide portion 61 and the upper end portion 63b of the second guide portion 63 and the space between the lower end portion 63a of the second guide portion 63 and the inner recovery groove 54 and through the exhaust tub 30 is formed in the exhaust tub 30. The depth of the lower end portion 63a of the second guide portion 63 entering the inner recovery groove 54 is small, and hence the second exhaust passage P2 has remarkably small pressure loss as compared with the remaining passages T1, T3 and T4. When the exhaust pipe 38 is forcibly exhausted, therefore, the downflow of the clean air introduced into the treatment cup 5 from the space between the spin chuck 4 and the inner edge portion of the treatment cup 5 (the upper end portion 36b of the fourth guard 36) exclusively circulates through the second exhaust passage P2, and is guided to the exhaust port 37. Thus, a current flowing into the second exhaust passage P2 through the first recovery port 92 is formed from the periphery of the wafer W held by the spin chuck 4.

After the first recovery port 92 is formed to be opposed to the peripheral edge portion of the wafer W, the control unit 80 opens the SPM valve 19 while continuously rotating the wafer W. Thus, the SPM is discharged from the treatment solution nozzle 6 toward the surface of the rotated wafer W (S5: an SPM treatment).

In this SPM treatment, the control unit 80 controls the nozzle driving mechanism 13, to swing the nozzle arm 11 in the prescribed angular range. Thus, the supply position on the surface of the wafer W to which the SPM from the treatment solution nozzle 6 is guided reciprocates in the range reaching the peripheral edge portion of the wafer W from the rotation center of the wafer W while drawing an arcuate locus intersecting with the rotational direction of the wafer W. The SPM supplied to the surface of the wafer W spreads on the overall region of surface of the wafer W. Thus, the SPM is uniformly supplied to the overall region of surface of the wafer W. When the SPM is supplied to the surface of the wafer W, strong oxidizing force of peroxomonosulfuric acid contained in the SPM acts on the resist, to remove the resist from the surface of the wafer W. When the SPM is supplied to the surface of the wafer W, a mist of the SPM is formed. The SPM supplied to the surface of the wafer W splashes sidewise from the peripheral edge portion of the wafer W.

The SPM drained from the peripheral edge portion of the wafer W to splash sidewise is captured by the first recovery port 92. The SPM flows down along the inner surface of the first guide portion 61, is collected in the inner recovery groove 54, and recovered in the recovery tank from the inner recovery groove 54 through the first recovery mechanism 55.

At this time, the second to fourth guards 34, 35 and 36 approach one another while keeping extremely small clearances between the upper end portions thereof, the folded portion 36c of the fourth guard 36 horizontally overlaps with the upper end portion 35b of the third guard 35 and the folded portion 35c of the third guard 35 horizontally overlaps with the upper end portion 63b of the second guide portion 63, whereby the mist of the SPM is prevented from entering the space between the second guide portion 63 and the third guard 35 and the space between the third guard 35 and the fourth guard 36.

The atmosphere containing the mist of the SPM is exhausted to the exhaust port 37 from the first recovery port 92 through the second exhaust passage P2. The atmosphere containing the mist of the SPM in the periphery of the wafer W is exhausted through the first recovery port 92 opposed to the peripheral edge portion of the wafer W, whereby the mist of the SPM can be efficiently eliminated from the periphery of the wafer W.

At this time, the lower end portion 63a of the second guide portion 63 enters the inner recovery groove 54, whereby the second exhaust passage P2 has a second folded passage 97 folded from a vertically downwardly directed state to a vertically upwardly directed state in this portion. In the process of circulating through the second folded passage 97, the mist of the SPM contained in the atmosphere adheres to and is captured by the lower end portion 63a of the second guide portion 63 or the outer wall portion 53 of the second cup 32. Therefore, the atmosphere containing the mist of the SPM can be gas-liquid separated in the process of circulating through the second exhaust passage P2. The SPM captured by the lower end portion 63a or the outer wall portion 53 is guided to the first recovery mechanism 55 through the inner recovery groove 54.

When a prescribed SPM treating time elapses from the start of the supply of the SPM to the wafer W, the control unit 80 closes the SPM valve 19, to stop supplying the SPM from the treatment solution nozzle 6. The control unit 80 further drives the first lifting mechanisms 81 to move the first guard 33 to the upper position, and forms the first waste liquid port 91 to be opposed to the peripheral edge portion of the wafer W (see FIG. 5B). The control unit 80 further drives the nozzle driving mechanism 13 to stop swinging the nozzle arm 11, whereby the treatment solution nozzle 6 is stopped on the wafer W.

After the first waste liquid port 91 is formed to be opposed to the peripheral edge portion of the wafer W, the control unit 80 opens the DIW valve 21 while continuously rotating the wafer W. Thus, the DIW is discharged from the treatment solution nozzle 6 toward the central portion of the surface of the rotated wafer W (S6: an intermediate rinsing treatment). In this intermediate rinsing treatment, the SPM adhering to the surface of the wafer W is washed out with the DIW supplied onto the surface of the wafer W. The DIW flowing toward the peripheral edge portion of the wafer W splashes sidewise from the peripheral edge portion of the wafer W, is captured by the first waste liquid port 91, collected in the waste liquid groove 44, and guided to the waste liquid treating equipment from the waste liquid groove 44 through the waste liquid mechanisms 45.

In this intermediate rinsing treatment, the mist of the SPM may remain in the periphery of the wafer W. The atmosphere containing the mists of the DIW and the SPM is exhausted to the exhaust port 37 from the first waste liquid port 91 through the first exhaust passage P1.

When the prescribed intermediate rinsing time elapses from the start of the supply of the DIW to the wafer W, the control unit 80 closes the DIW valve 21, to stop supplying the DIW from the treatment solution nozzle 6. The control unit 80 further opens the SC1 valve 20, whereby the SC1 is discharged from the treatment solution nozzle 6 to the surface of the wafer W (S7: an SC1 treatment).

In this SC1 treatment, the control unit 80 controls the nozzle driving mechanism 13, to swing the nozzle arm 11 in the prescribed angular range. Thus, the supply position on the surface of the wafer W to which the SC1 from the treatment solution nozzle 6 is guided reciprocates in the range reaching the peripheral edge portion of the wafer W from the rotation center of the wafer W while drawing an arcuate locus intersecting with the rotational direction of the wafer W. The SC1 supplied to the surface of the wafer W spreads on the overall region of surface of the wafer W. Thus, the SC1 is uniformly supplied to the overall region of surface of the wafer W. When the SC1 is supplied from the treatment solution nozzle 6 to the surface of the wafer W, the residue of the resist adhering to the surface of the wafer W and foreign matter such as particles can be removed due to the chemical ability of the SC1. When the SC1 is supplied to the surface of the wafer W, a mist of the SC1 is formed. The SC1 supplied to the surface of the wafer W splashes sidewise from the peripheral edge portion of the wafer W.

The SC1 splashing from the peripheral edge portion of the wafer W is captured by the first waste liquid port 91, collected in the waste liquid groove 44, and guided to the waste liquid treating equipment from the waste liquid groove 44 through the waste liquid mechanisms 45.

The atmosphere containing the mist of the SC1 is exhausted to the exhaust port 37 from the first waste liquid port 91 through the first exhaust passage P1. At this time, the mist of the SC1 contained in the atmosphere adheres to and is captured by the lower end portion 61a of the first guide portion 61 or the outer wall portion 43 of the first cup 31 in the process of circulating through the first folded passage 96. Therefore, the atmosphere containing the mist of the SC1 can be gas-liquid separated in the process of circulating through the first exhaust passage P1.

When a prescribed SC1 treating time elapses from the start of the supply of the SC1 to the wafer W, the control unit 80 closes the SC1 valve 20, to stop supplying the SC1 from the treatment solution nozzle 6. The control unit 80 further drives the nozzle driving mechanism 13 to stop swinging the nozzle arm 11, and the treatment solution nozzle 6 is stopped on the wafer W.

The control unit 80 further opens the DIW valve 21 while continuously rotating the wafer W. Thus, the DIW is discharged from the treatment solution nozzle 6 toward the central portion of the surface of the rotated wafer W (S8: an intermediate rinsing treatment). In this intermediate rinsing treatment, the SC1 adhering to the surface of the wafer W is washed out with the DIW supplied onto the surface of the wafer W. The DIW flowing toward the peripheral edge portion of the wafer W splashes sidewise from the peripheral edge portion of the wafer W, is captured by the first waste liquid port 91, collected in the waste liquid groove 44, and guided to the waste liquid treating equipment from the waste liquid groove 44 through the waste liquid mechanisms 45.

In this intermediate rinsing treatment, the mist of the SC1 may remain in the periphery of the wafer W. The atmosphere containing the mists of the DIW and the SC1 is exhausted to the exhaust port 37 from the first waste liquid port 91 through the first exhaust passage P1.

When the prescribed intermediate rinsing time elapses from the start of the supply of the DIW to the wafer W, the control unit 80 drives the first to third lifting mechanisms 81, 82 and 83 to move the first to third guards 33, 34 and 35 to the lower positions, and the upper end portion 61b of the first guide portion 61, the upper end portion 63b of the second guide portion 63 and the upper end portion 35b of the third guard 35 are arranged below the wafer W held by the spin chuck 4. Thus, an opening (a second waste liquid port) 94 opposed to the peripheral edge portion of the wafer W is formed between the upper end portion 35b of the third guard 35 and the upper end portion 36b of the fourth guard 36 (S9: a final rinsing treatment, see FIG. 5D).

At this time, the first to third guards 33, 34 and 35 are synchronously moved to the upper positions while keeping extremely small clearances between the upper end portion 61b of the first guide portion 61 and the upper end portion 63b of the second guide portion 63 and between the upper end portion 63b of the second guide portion 63 and the upper end portion 35b of the third guard 35 (while keeping relative positional relation between the first to third guards 33, 34 and 35). Thus, the DIW splashing from the wafer W can be prevented from entering the spaces between the first guide portion 61 and the second guide portion 63 and between the second guide portion 63 and the third guard 35 when the spin chuck 4 continuously rotates the wafer W and supplies the DIW.

When the second waste liquid port 94 is formed between the upper end portion 35b of the third guard 35 and the upper end portion 36b of the fourth guard 36 (a second waste liquid discharge state), the first guard 33 most approaches the first cup 31. Therefore, the first passage T1 reaching the exhaust port 37 through the space between the lower end portion 61a of the first guide portion 61 and the waste liquid groove 44 and through the exhaust tub 30 has relatively large pressure loss, as hereinabove described.

In this second waste liquid discharge state, the first and second guards 33 and 34 most approach the second cup 32. Therefore, the second passage T2 reaching the exhaust port 37 through the clearance between the upper end portion 61b of the first guide portion 61 and the upper end portion 63b of the second guide portion 63 and the space between the lower end portion 63a of the second guide portion 63 and the inner recovery groove 54 and through the exhaust tub 30 has relatively large pressure loss, as hereinabove described.

In the second waste liquid discharge state, further, the second and third guards 34 and 35 most approach each other. Therefore, the third passage T3 reaching the exhaust port 37 through the space between the upper end portion 63b of the second guide portion 63 and the upper end portion 35b of the third guard 35 and the space between the lower end portion 35a of the third guard 35 and the outer recovery groove 68 and through the exhaust tub 30 has relatively large pressure loss, as hereinabove described.

On the other hand, a fourth exhaust passage P4 reaching the exhaust port 37 from the second waste liquid port 94 through the space between the upper end portion 35b of the third guard 35 and the upper end portion 36b of the fourth guard 36 is formed in the exhaust tub 30. The fourth exhaust passage P4 has remarkably small pressure loss as compared with the remaining passages T1, T2 and T3. When the exhaust pipe 38 is forcibly exhausted, therefore, the downflow of the clean air introduced into the treatment cup 5 from the space between the spin chuck 4 and the inner edge portion of the treatment cup 5 (the upper end portion 36b of the fourth guard 36) exclusively circulates through the fourth exhaust passage P4 and is guided to the exhaust port 37. Thus, a current flowing into the fourth exhaust passage P4 through the second waste liquid port 94 is formed from the periphery of the wafer W held by the spin chuck 4.

In this final rinsing treatment, the DIW supplied onto the surface of the wafer W spreads on the overall region of the surface of the wafer W, to wash out the chemical solution (the SC1, for example) adhering to the surface of the wafer W. The DIW is drained due to the rotation of the wafer W, and splashes sidewise from the peripheral edge portion thereof.

The DIW drained from the peripheral edge portion of the wafer W to splash sidewise is captured by the second waste liquid port 94. The DIW flows down along the inner wall of the fourth guard 36 and the inner surface of the sidewall of the exhaust tub 30, is collected in the bottom portion of the exhaust tub 30, and guided to the waste liquid treating equipment from the bottom portion of the exhaust tub 30 through the waste liquid pipe 40.

At this time, the first to third guards 33, 34 and 35 approach one another while keeping extremely small clearances between the upper end portions thereof, the folded portion 35c of the third guard 35 horizontally overlaps with the upper end portion 63b of the second guide portion 63 and the folded portion 63c of the second guide portion 63 horizontally overlaps with the upper end portion 61b of the first guide portion 61, whereby the DIW is prevented from entering the space between the first guide portion 61 and the second guide portion 63 and the space between the second guide portion 63 and the third guard 35.

The atmosphere containing the mist of the DIW is exhausted to the exhaust port 37 from the first waste liquid port 91 through the first exhaust passage P1.

When a prescribed final rinsing time elapses from the start of the supply of the DIW, the DIW valve 21 is closed, to stop supplying the DIW to the wafer W. The control unit 80 drives the nozzle driving mechanism 13, to return the treatment solution nozzle 6 to the retracted position on the side of the treatment cup 5. Thereafter the control unit 80 accelerates the rotational speed of the wafer W to a spin drying rotational speed (3000 rpm, for example). Thus, the DIW adhering to the surface of the wafer W after the final rinsing treatment is centrifugally drained and dried (S10: a spin drying treatment). In this spin drying treatment, the DIW splashing from the peripheral edge portion of the wafer W adheres to the inner wall of the fourth guard 36.

After termination of the spin drying, the control unit 80 controls the motor 8, to stop rotating the wafer W (step S11). The control unit 80 further controls the fourth lifting mechanisms 84, to move the fourth guard 36 to the lower position (the state shown in FIG. 2). Then, the transport robot (not shown) discharges the wafer W (step S12).

According to this embodiment, as hereinabove described, the chemical solutions (the hydrofluoric acid, the SPM and the SC1) supplied from the treatment solution nozzle 6 to the wafer W rotated by the spin chuck 4 splash sidewise from the peripheral edge portion of the wafer W, and are captured by the capture ports (the first waste liquid port 91 and the first and second recovery ports 92 and 93) opposed to the peripheral edge portion of the wafer W. The chemical solutions are supplied from the treatment solution nozzle 6 to the wafer W, whereby the mists of the chemical solutions are formed around the wafer W. When the exhaust pipe 38 is exhausted, the atmosphere containing the mists of the chemical solutions moves to the exhaust port 37 from the capture ports 91 to 93 through the first to third exhaust passages P1, P2 and P3, and is exhausted through the exhaust pipe 38. The first to third exhaust passages P1, P2 and P3 are formed in the exhaust tub 30, whereby the atmosphere containing the mists of the chemical solutions in the exhaust tub 30 can be prevented or inhibited from leaking out of the exhaust tub 30.

When the first waste liquid port 91 is opposed to the peripheral edge portion of the wafer W, the first exhaust passage P1 reaching the exhaust port 37 from the first waste liquid port 91 is formed in the exhaust tub 30. When the first recovery port 92 is opposed to the peripheral edge portion of the wafer W, the second exhaust passage P2 reaching the exhaust port 37 from the first recovery port 92 is formed in the exhaust tub 30. When the second recovery port 93 is opposed to the peripheral edge portion of the wafer W, the third exhaust passage P3 reaching the exhaust port 37 from the second recovery port 93 is formed in the exhaust tub 30. When the second waste liquid port 94 is opposed to the peripheral edge portion of the wafer W, the fourth exhaust passage P4 reaching the exhaust port 37 from the second waste liquid port 94 is formed in the exhaust tub 30. When any one of the capture ports 91, 92, 93 and 94 is opened to be opposed to the peripheral edge portion of the wafer W, therefore, the atmosphere containing the mists of the chemical solutions (the hydrofluoric acid, the SPM and the SC1) can be exhausted through this capture port 91, 92, 93 or 94. Thus, the atmosphere containing the mists of the chemical solutions around the wafer W is exhausted through the capture port 91, 92, 93 or 94 opposed to the peripheral edge portion of the wafer W, whereby the mists of the chemical solutions can be efficiently eliminated from the periphery of the wafer W.

The mist of the hydrofluoric acid flowing into the third exhaust passage P3 from the second recovery port 93 is recovered in the outer recovery groove 68 in the process of circulating through the third exhaust passage P3, while the mist of the SPM flowing into the second exhaust passage P2 from the first recovery port 92 is recovered in the inner recovery groove 54 in the process of circulating through the second exhaust passage P2. Thus, the recovery efficiency for the hydrofluoric acid and that for the SPM can be improved.

Further, the first to third exhaust passages P1, P2 and P3 formed in the clearances between the first to third guards 33, 34 and 35 and the first to third cups 31, 32 and 64 have the first to third folded passages 96, 97 and 98. Therefore, the mists of the chemical solutions (the SC1, the SPM and the hydrofluoric acid) contained in the atmosphere circulating through the first to third exhaust passages P1, P2 and P3 is captured by the wall surfaces of the first to third guards 33, 34 and 35 or the wall surfaces of the first to third cups 31, 32 and 64 partitioning the first to third folded passages 96, 97 and 98. In other words, the atmosphere containing the chemical solutions around the wafer W can be gas-liquid separated in the process of circulating through the first to third exhaust passages P1, P2 and P3. Thus, no gas-liquid separator may be separately provided, whereby the cost can be reduced.

Further, the atmosphere in the treatment chamber 3 is introduced into the exhaust tub 30 through the inlet 39 formed in the sidewall of the treatment chamber 3 and exhausted through the exhaust pipe 38. Therefore, equipment dedicated to exhaustion of the treatment chamber 3 can be omitted, and the cost can be reduced.

While the embodiment of the present invention has been described, the present invention may be embodied in other ways.

For example, while the resist removing treatment for removing the unnecessary resist from the surface of the wafer W is executed with the SPM in the aforementioned embodiment, the wafer W may alternatively be treated with another treatment solution (a chemical solution or a rinsing solution). In this case, an SC2 (a hydrochloric acid/hydrogen peroxide mixture), buffered hydrofluoric acid (buffered HF: a hydrofluoric acid-ammonium fluoride mixture) and the like can be listed as chemical solutions, in addition to the aforementioned hydrofluoric acid and SC1.

While the DIW is employed as the rinse solution in the aforementioned embodiment, carbonated water, electrolytic ion water, hydrogen water, magnetic water, ammonia water having a diluted concentration (about 1 ppm, for example) or the like can be employed in place thereof.

While the present invention has been described in detail byway of the embodiments thereof, it should be understood that these embodiments are merely illustrative of the technical principles of the present invention but not limitative of the invention. The spirit and scope of the present invention are to be limited only by the appended claims.

This application corresponds to Japanese Patent Application No. 2008-168414 filed with the Japanese Patent Office on Jun. 27, 2008, the entire disclosure of which is incorporated herein by reference.

What is claimed is:

1. A substrate treatment apparatus including:
a substrate holding unit horizontally holding a substrate;
a substrate rotating unit rotating the substrate held by the substrate holding unit around a vertical axis of rotation;
a treatment solution supply unit for supplying a treatment solution to the substrate rotated by the substrate rotating unit;
an exhaust tub having an exhaust port and storing the substrate holding unit therein;
a plurality of guards stored in the exhaust tub and vertically movable independently of one another;
an exhaust passage forming unit forming a capture port opposed to the peripheral edge portion of the substrate held by the substrate holding unit for capturing the treatment solution splashing from the substrate while forming an exhaust passage reaching the exhaust port from the capture port by vertically moving the guards; and
an exhaust pipe connected to the exhaust port for exhausting the atmosphere in the exhaust tub through the exhaust port.

2. The substrate treatment apparatus according to claim 1, wherein
pressure loss in the exhaust passage formed by the exhaust passage forming unit is rendered smaller than pressure loss in another passage reaching the exhaust port from the peripheral portion of the substrate held by the substrate holding unit without through the exhaust passage.

3. The substrate treatment apparatus according to claim 1, further including a cup for collecting the treatment solution received by each guard correspondingly to each guard, wherein
each guard includes a guide portion guiding the treatment solution toward the cup, and
the exhaust passage includes a folded passage formed in a clearance between the cup and the guide portion.

4. The substrate treatment apparatus according to claim 1, further including a treatment chamber storing the exhaust tub, wherein
an inlet for introducing the atmosphere outside the exhaust tub in the treatment chamber into the exhaust tub is formed in the sidewall of the exhaust tub.
